(19) United States
(12) Patent Application Publication
(10) Pub. No.: US 2005/0027084 A1
(43) Pub. Date: Feb. 3, 2005

(54) Production of vinyl halide from single carbon feedstocks

(76) Inventors: William D. Clarke, Brazoria, TX (US); Terry D. Haymon, Brazoria, TX (US); John P. Henley, Midland, MI (US); Daniel A. Hickman, Midland, MI (US); Mark E. Jones, Midland, MI (US); Matt C. Miller, Lake Jackson, TX (US); Thomas E. Morris, Lake Jackson, TX (US); Daniel J. Reed, Angleton, TX (US); Lawrence J. Samson, Lake Jackson, TX (US); Albert E. Schweizer, Midland, MI (US); Steve A. Smith, Baton Rogue, LA (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/477,479

(22) PCT Filed: Apr. 23, 2002
(86) PCT No.: PCT/US02/13012

Related U.S. Application Data
(60) Provisional application No. 60/292,945, filed on May 23, 2001.

(51) Int. Cl. C08F 2/00

(52) U.S. Cl. 526/68; 526/344; 422/131

(57) ABSTRACT

The preparation of vinyl halide monomer, and further to polyvinyl halide, starting from C₁ compounds, involving conversion of methane or methanol to methyl halide; condensation of methyl halide to ethylene and co-product hydrogen halide; oxidative halogenation of ethylene to vinyl halide monomer; separation of vinyl halide monomer from any methyl halide present in the vinyl halide monomer stream; optional recycling of the methyl halide recovered to the condensation step; and recovery and optional recycling of the co-product hydrogen halide. Optionally, the vinyl halide monomer may be polymerized to polyvinyl halide to facilitate separation of the monomer from methyl halide. Methyl halide may be obtained via oxidative halogenation of methane in the presence of a rare earth halide or rare earth oxyhalide catalyst. Optionally, the methyl halide may be converted to methanol.

This invention pertains to an integrated process for converting methane or other single carbon material, such as methanol, to an unsaturated C₂ halide monomer, such as vinyl chloride monomer, and optionally, further converting the vinyl halide monomer to polyvinyl halide.

Vinyl chloride is a well known material, used primarily as a monomer for manufacturing polyvinyl chloride and numerous vinyl chloride-containing copolymers. Various methods are currently employed to make vinyl chloride monomer (VCM). See, for example, K. Weissermel and H.-J. Arpe, Industrial Organic Chemistry, 2^{nd} Edition, VCH Verlagsgesellshaft mbH, Weinheim, Germany, 1993, Chapter 9, pp. 213-233. New and useful methods of making VCM would be highly desirable, particularly with respect to its manufacture using, as a starting material, inexpensive methane or other single carbon compound, such as methanol.

In a first aspect, this invention provides for a novel process of preparing vinyl halide monomer. In this aspect, the process comprises (a) contacting methane with a first source of halogen and, optionally, a first source of oxygen in the presence of a first oxidative halogenation catalyst under oxidative halogenation process conditions sufficient to prepare methyl halide and, optionally, dihalomethane, the catalyst comprising a rare earth halide or rare earth oxyhalide, being substantially free of copper and iron, with the proviso that when cerium is present in the catalyst, then at least one other rare earth element is also present in the catalyst; (b) contacting the methyl halide and, optionally, dihalomethane thus produced with a condensation catalyst under condensation conditions sufficient to prepare ethylene and co-product hydrogen halide; (c) contacting the ethylene with a second source of halogen and, optionally, a second source of oxygen, in the presence of a second oxidative halogenation catalyst under oxidative halogenation process conditions sufficient to prepare vinyl halide monomer; and optionally (d) recycling the co-product hydrogen halide from step (b) to steps (a) and (c).

In the aforementioned process, conversion of ethylene to vinyl halide monomer in step (c) can be effected by conventional prior art catalysts, for example, supported copper catalysts, that produce 1,2-dihaloethane, which subsequently is thermally cracked to vinyl halide monomer typically in a separate thermal cracker. Alternatively, conversion of ethylene to vinyl halide monomer in step (c) can be effected by use of the aforementioned catalyst comprising a rare earth halide or rare earth oxyhalide compound, essentially free of iron and copper, and with the proviso that when cerium is present in the catalyst, then at least one other rare earth element is also present in the catalyst. When the rare earth catalyst is used, then vinyl halide is formed directly without the need for a separate thermal cracking reactor. Vinyl halide can also be made by mixing the ethylene produced in step (b) with the methane feed to step (a) to yield a reactor effluent from step (a) containing methyl halide and vinyl halide. In this latter design, the first and second sources of halogen, the first and second sources of oxygen, and the first and second oxidative halogenation catalysts are in each instance identical, since steps (a) and (c) are combined in the same reactor. Accordingly, separation of methyl halide and vinyl halide prior to conversion of the methyl halide to ethylene provides a two-reactor system of producing vinyl halide from methane.

Thus, in this first aspect, the invention involves a novel integrated process for activating methane to form methyl halide, then condensing methyl halide to ethylene and co-product hydrogen halide, and thereafter, directly utilizing the stream containing ethylene and hydrogen halide in an oxidative halogenation process of converting ethylene to vinyl halide monomer. In a preferred method of conducting this process as described hereinabove, the step to produce methyl halide and the step to produce vinyl halide monomer are combined in one reactor. Accordingly, the process can be beneficially convert methane to vinyl halide monomer in a two-reactor system.

The novel oxidative halogenation process of this invention advantageously converts methane in the presence of a source of halogen and, optionally, a source of oxygen into a halogenated C₁ hydrocarbon product having an increased number of halogen substituents as compared with the reactant hydrocarbon (that is, methane), such halogenated products being exemplified, preferably, by methyl chloride and methyl bromide. In this process, the use of a source of oxygen is preferred. In a preferred embodiment, the process of this invention can be beneficially employed to oxidatively chlorinate methane in the presence of hydrogen chloride and oxygen to form methyl chloride. Methyl chloride is beneficially employed in the preparation of methanol, dimethyl ether, acetic acid, light olefins, such as ethylene, propylene, and butylenes, and higher hydrocarbons, such as gasolines. Ethylene derived from methyl chloride may be directly employed in the preparation of vinyl halide monomer. As compared with prior art processes, the process of this invention advantageously produces the monohalogenated C₁ hydrocarbon in high selectivity with essentially no perhalogenated C₁ halocarbon, such as carbon tetrachloride, and low levels, if any, of undesirable oxygenates, such as, carbon monoxide and carbon dioxide. The lower selectivity to perhalogenated C₁ halocarbons and undesirable oxygenated by-products correlates with a more efficient use of reactant hydrocarbon, a higher productivity of the desired monohalogenated C₁ hydrocarbon product, and fewer separation and waste disposal problems.

In addition to the above advantages, the catalyst employed in the process of this invention does not require a conventional carrier or support, such as alumina or silica. Instead, the catalyst employed in this invention beneficially comprises a rare earth halide or rare earth oxyhalide that uniquely functions both as a catalyst support and as a source of a further catalytically active rare earth component Unlike many heterogeneous catalysts of the prior art, the rare earth halide catalyst of this invention is beneficially soluble in water. Accordingly, should process equipment, such as filters, valves, circulating tubes, and small or intricate parts of reactors, become plugged with particles of the rare earth halide catalyst, then a simple water wash can advantageously dissolve the plugged particles and restore the equipment to working order. As a further advantage, the rare earth halide and rare earth oxyhalide catalysts employed in the process of this invention exhibit acceptable reaction rates and evidence of long lifetimes. In preferred embodiments of the invention, essentially no deactivation of these catalysts has been observed over the run times tested.

In a second aspect, this invention provides for a novel process of preparing methyl alcohol, dimethyl ether, or a combination thereof. The process in this aspect comprises (a) contacting methane with a source of halogen and, optionally, a source of oxygen in the presence of a catalyst comprising a rare earth halide or rare earth oxyhalide under monohalogenation process conditions sufficient to prepare methyl halide, the rare earth halide or rare earth oxyhalide catalyst being substantially free of copper and iron, with the proviso that when cerium is present in the catalyst, then at least one other rare earth element is also present in the catalyst; and thereafter (b) contacting the methyl halide thus produced with water under hydrolysis conditions sufficient to prepare methyl alcohol, dimethyl ether, or a combination thereof and co-product hydrogen halide; and optionally (c) recycling the co-product hydrogen halide to the oxidative halogenation process of step (a).

In this second aspect of the invention, methane is beneficially converted into methyl alcohol via intermediate methyl halide. The method of this invention advantageously produces methyl alcohol without the use of synthesis gas. Accordingly, a syngas reactor, which involves costly steam reforming or partial oxidation units, is not needed for the process of this invention. Instead, conventional, cost effective engineering may be employed. Accordingly, the process invention can readily be accommodated in remote locations around the world where methane sources are currently stranded. Since methyl alcohol is more easily and safely transported than methane gas, the conversion of methane to methyl alcohol by the simple process of this invention would free-up inaccessible methane resources. In another aspect of this invention, the methanol so produced and transported could thereafter be reconverted with hydrogen chloride to methyl chloride, which could be used to prepare vinyl chloride as described hereinabove.

In another broad respect, this invention provides a process of preparing a vinyl halide stream comprising vinyl halide monomer or polyvinyl halide, the process comprising: (a) contacting methane with a first source of halogen, and optionally, a first source of oxygen in the presence of a first oxidative halogenation catalyst under process conditions sufficient to prepare methyl halide, the catalyst comprising a rare earth halide or rare earth oxyhalide being essentially free of iron and copper, with the proviso that when the catalyst contains cerium, the catalyst also contains at least one other rare earth element; (b) contacting the methyl halide with a condensation catalyst under condensation conditions sufficient to prepare a product stream containing ethylene and co-product hydrogen halide; (c) contacting the ethylene from process step (b) with a second source of halogen, and optionally, a second source of oxygen in the presence of a second oxidative halogenation catalyst under oxidative halogenation process conditions, and optional thermal cracking conditions, sufficient to prepare a vinyl halide monomer stream which may contain methyl halide; (d) separating the vinyl halide monomer from any methyl halide present to recover a vinyl halide stream and a methyl halide stream, the vinyl halide stream comprising vinyl halide monomer or polyvinyl halide; (e) recovering co-product hydrogen halide produced in step (b); (f) optionally, recycling the methyl halide from process step (d) to process step (b); and (g) optionally, recycling the recovered co-product hydrogen halide to process steps (a) and/or (c). Optionally, separation step (d) may be effected by polymerizing vinyl halide monomer to form polyvinyl halide.

The aforementioned process of preparing vinyl halide monomer or polyvinyl halide polymer may be practiced whereby the two sources of halogen are both hydrogen chloride, and oxygen is employed in process steps (a) and (c). In step (c) the second oxidative halogenation catalyst may also comprise a rare earth halide or rare earth oxyhalide being essentially free of iron and copper, with the proviso that when the catalyst contains cerium, the catalyst also contains at least one other rare earth element. In one embodiment, process steps (a) and (c) may occur simultaneously in a single reactor with the aforementioned rare earth halide or rare earth oxyhalide being employed as catalyst for both process steps.

In another broad respect, this invention is a process of preparing a vinyl halide stream comprising vinyl halide monomer or polyvinyl halide, the process comprising: (a) converting methanol to a methyl halide; (b) contacting the methyl halide with a condensation catalyst under condensation conditions sufficient to prepare ethylene and co-product hydrogen halide; (c) contacting the ethylene from process step (b) with a source of halogen, and optionally, a source of oxygen in the presence of an oxidative halogenation catalyst under oxidative halogenation process conditions, and optional thermal cracking conditions, sufficient to prepare a vinyl halide monomer stream which may contain methyl halide; (d) separating the vinyl halide monomer and any methyl halide to recover a vinyl halide stream comprising vinyl halide monomer or polyvinyl halide and a methyl halide stream; (e) recovering the co-product hydrogen halide produced in step (b); (f) optionally, recycling the methyl halide from process step (d) to process step (b); and (g) optionally recycling the recovered co-product hydrogen halide to process steps (a) and/or (c). Optionally, separation step (d) may be effected by polymerizing vinyl halide monomer to form polyvinyl halide.

In one embodiment to prepare VCM from methanol, the methanol is formed by hydrolyzing methyl chloride, which itself was prepared by contacting methane, oxygen, and a chlorine source in the presence of an oxidative halogenation catalyst under process conditions sufficient to prepare methyl halide. The oxidative halogenation catalyst for such process step may comprise the aforementioned rare earth halide or rare earth oxyhalide being essentially free of iron and copper, with the proviso that when the catalyst contains cerium, the catalyst also contains at least one other rare earth element. In one embodiment, the source of halogen to convert methanol to methyl halide in step (a) and to prepare vinyl halide monomer in step (c) are both hydrogen chloride, and oxygen is employed in process step (c) as well. In one embodiment, in step (c) the oxidative halogenation catalyst comprises the aforementioned rare earth halide or rare earth oxyhalide being essentially free of iron and copper, with the proviso that when the catalyst contains cerium, the catalyst also contains at least one other rare earth element. In one embodiment, the process further comprises recovering cis/trans-1,2-dihaloethylene from the vinyl halide monomer stream and hydrogenating the recovered cis/trans-1,2-dihaloethylene to form 1,2-dihaloethane (for example, EDC, also known as “ethylene dichloride”), which may be recycled, if desired, to the oxidative halogenation reactor for converting ethylene to vinyl halide monomer.

In another broad respect, this invention is an apparatus for making a vinyl halide stream comprising vinyl halide monomer or polyvinyl halide, the apparatus comprising: (a) a first reactor that catalytically reacts together methane, oxygen, and at least one halogen source to form methyl halide; (b) a second reactor that condenses the methyl halide to form ethylene and hydrogen halide; (c) a third reactor that catalytically reacts together the ethylene, oxygen, and at least one halogen source to form a stream comprising vinyl halide monomer and optionally methyl halide; (d) a recovery subsystem for the recovery of hydrogen halide; (e) a separation subsystem that separates the stream containing the vinyl halide monomer and methyl halide to form a vinyl halide stream comprising vinyl halide monomer or polyvinyl halide and a methyl halide stream; (f) optionally, a line that recycles the methyl halide to the second reactor (b); and (g) optionally, a line that recycles the recovered hydrogen halide to the first and/or third reactors (a) and (c). Optionally, the separation subsystem (e) that separates the methyl halide from the vinyl halide monomer may comprise a polymerization reactor, which functions to polymerize the vinyl halide to polyvinyl halide, thereby separating the monomer from methyl halide. In one embodiment, the first and third reactors (a) and (c) are combined into a single reactor.

In another broad respect, this invention is an apparatus for making a vinyl halide stream comprising vinyl halide monomer or polyvinyl halide, the apparatus comprising: (a) a first reactor that converts methanol to methyl halide; (b) a second reactor that condenses the methyl halide to form ethylene and hydrogen halide; (c) a third reactor that catalytically reacts together the ethylene, oxygen, and at least one halogen source to form a stream comprising vinyl halide monomer and optionally methyl halide; (d) a recovery subsystem for the recovery of hydrogen halide; (e) a separation subsystem that separates the stream containing vinyl halide monomer and any methyl halide present to provide a vinyl halide stream comprising vinyl halide monomer or polyvinyl halide and a methyl halide stream; (f) optionally, a line that recycles the methyl halide to the second reactor (b); and (g) optionally, a line that recycles the recovered hydrogen halide to the first and/or third reactors (a) and (c). Optionally, the separation subsystem (e) that separates the methyl halide from the vinyl halide monomer may comprise a polymerization reactor, which functions to polymerize the vinyl halide monomer to polyvinyl halide, thereby separating the monomer from methyl halide.

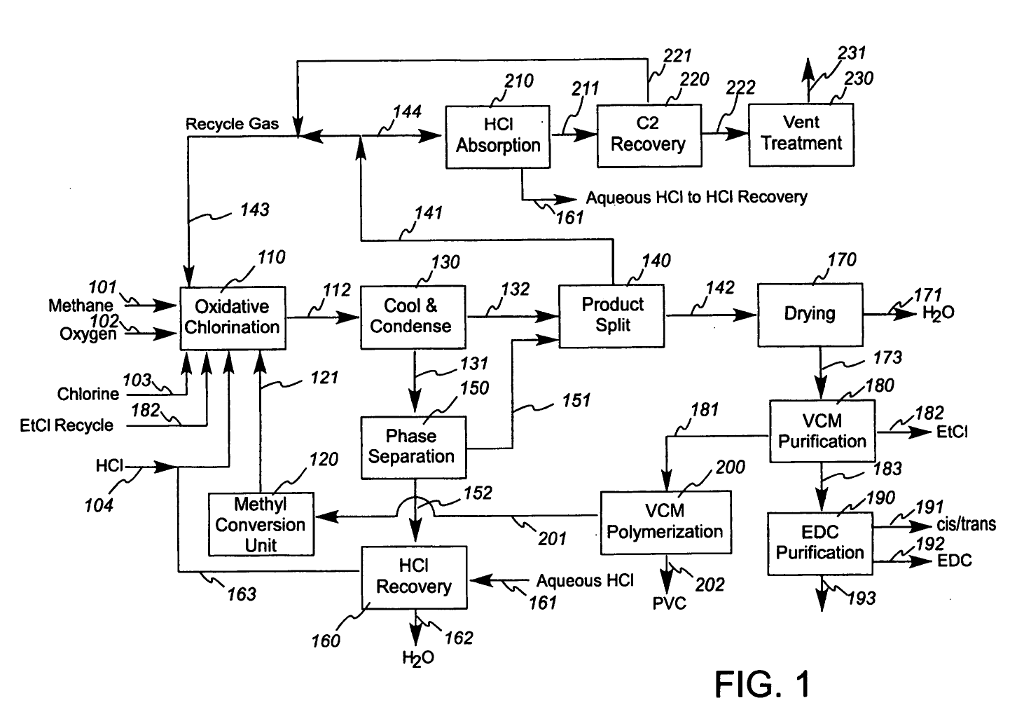

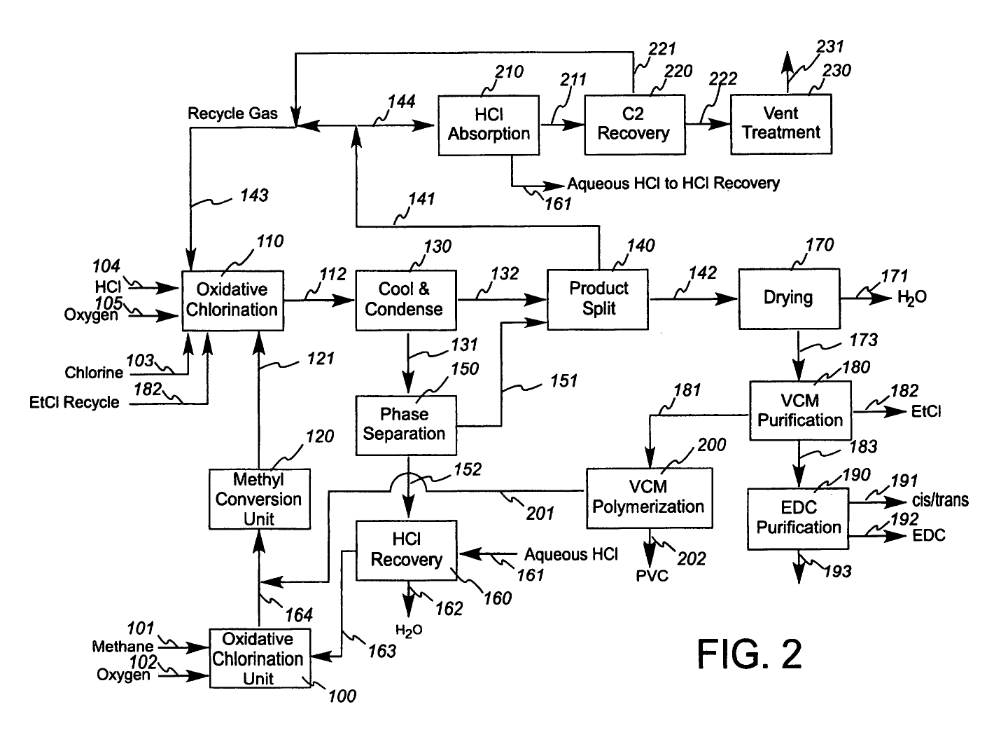

FIGS. 1 and 2 illustrate a process for converting methane to a vinyl halide monomer, such as vinyl chloride monomer, and subsequently to polyvinyl halide.

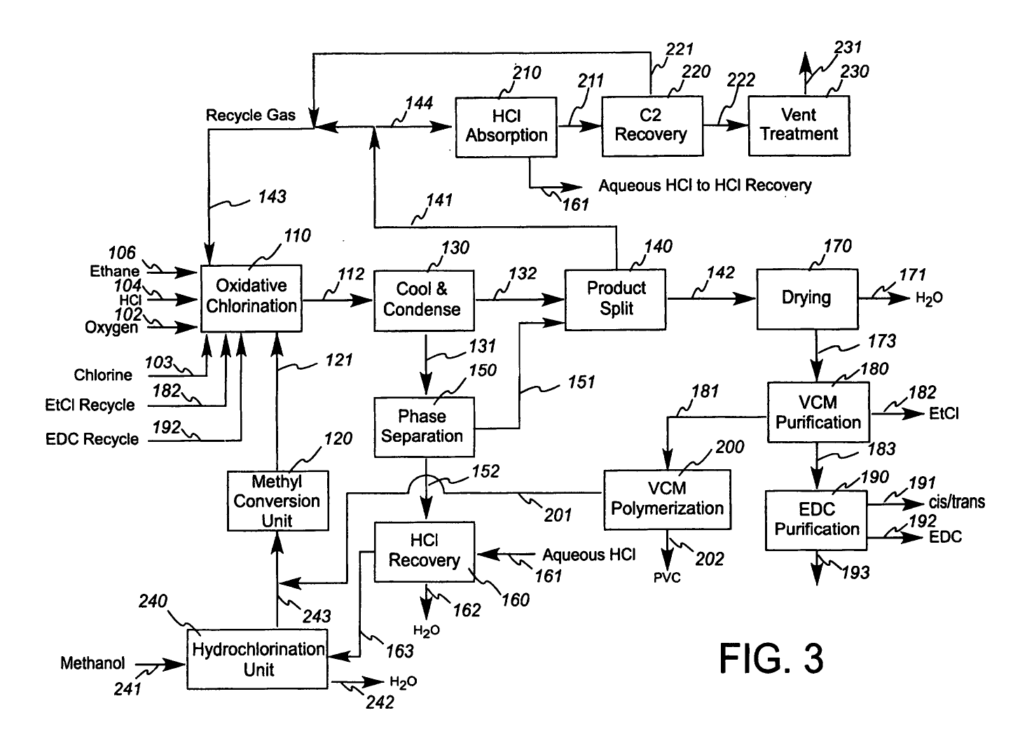

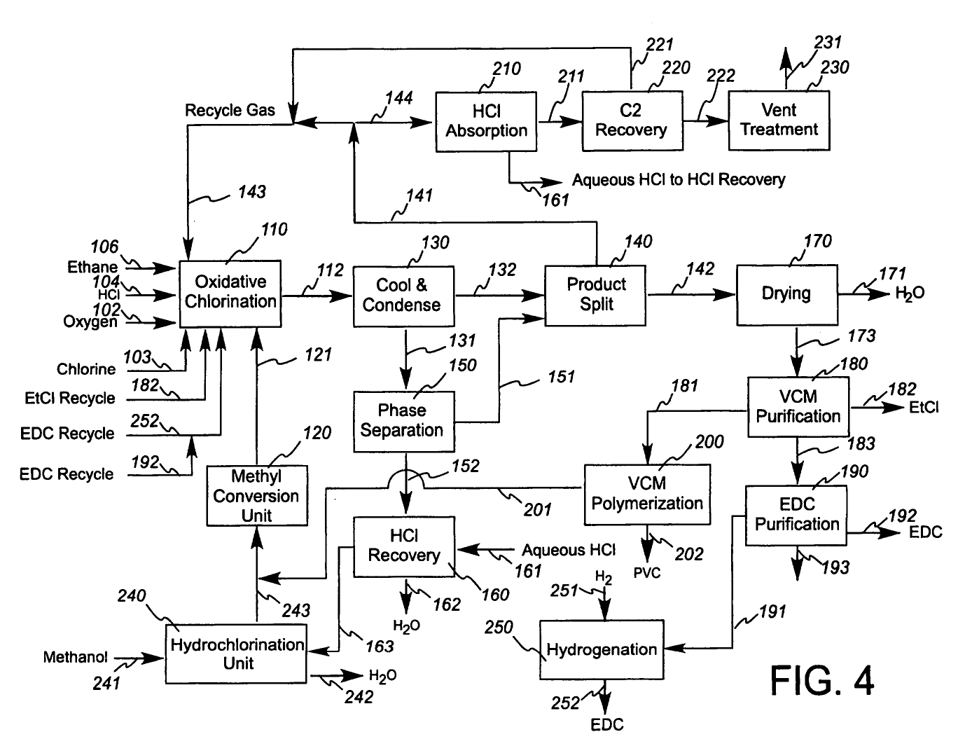

FIGS. 3 and 4 illustrate a process for converting methanol to a vinyl halide monomer, such as vinyl chloride monomer, and subsequently to polyvinyl halide.

In a first aspect, in the novel oxidative halogenation process of this invention, a halogenated C₁ hydrocarbon product, preferably a monohalogenated C₁ hydrocarbon product, is selectively produced with essentially no formation of perhalogenated C₁ chlorocarbon product and with advantageously low levels of by-products, such as, COₓ oxygenates (CO and CO₂). In this aspect, the novel process of this invention comprises contacting a reactant C₁ hydrocarbon, namely methane, with a source of halogen and, optionally, a source of oxygen in the presence of a catalyst under process conditions sufficient to prepare a halogenated C₁ hydrocarbon having a greater number of halogen substituents as compared with the reactant hydrocarbon (that is, methane). Monohalogenated product, namely, methyl halide, is the preferred product. The use of a source of oxygen is preferred. The unique catalyst employed in the oxidative halogenation process of this invention comprises a rare earth halide or rare earth oxyhalide compound that is substantially free of copper and iron, with the further proviso that when cerium is present in the catalyst, at least one other rare earth element is also present in the catalyst. In another preferred embodiment, the source of halogen is hydrogen chloride. In yet another preferred embodiment, the rare earth halide or rare earth oxyhalide is a rare earth chloride or rare earth oxychloride. In yet another preferred embodiment, the rare earth is lanthanum or a mixture of lanthanum with other rare earth elements.

In a second aspect, this invention provides for a novel process of preparing methyl alcohol, dimethyl ether, or a combination thereof. The process in this aspect comprises (a) contacting methane with a source of halogen, and optionally, a source of oxygen in the presence of a catalyst comprising a rare earth halide or rare earth oxyhalide under monohalogenation process conditions sufficient to prepare methyl halide, preferably, methyl chloride, the rare earth halide or rare earth oxyhalide catalyst being substantially free of copper and iron, with the proviso that when cerium is present in the catalyst, then at least one other rare earth element is also present in the catalyst; and thereafter (b) contacting the methyl halide thus produced with water under hydrolysis conditions sufficient to prepare methyl alcohol, dimethyl ether, or a combination thereof, and co-product hydrogen halide; and optionally (c) recycling the co-product hydrogen halide to the oxidative halogenation process of step (a). In a preferred embodiment of this invention, oxygen is employed in step (a). In another preferred embodiment, the source of halogen is hydrogen chloride. In yet another preferred embodiment, the rare earth halide or rare earth oxyhalide is a rare earth chloride or rare earth oxychloride. In yet another preferred embodiment, the rare earth is lanthanum or a mixture of lanthanum with other rare earth elements.

In a third aspect, this invention provides for a process of preparing a vinyl halide stream comprising vinyl halide monomer or polyvinyl halide, the process comprising: (a) contacting methane with a first source of halogen, and optionally, a first source of oxygen in the presence of a first oxidative halogenation catalyst under process conditions sufficient to prepare methyl halide, the catalyst comprising a rare earth halide or rare earth oxyhalide being essentially free of iron and copper, with the proviso that when the catalyst contains cerium, the catalyst also contains at least one other rare earth element; (b) contacting the methyl halide with a condensation catalyst under condensation conditions sufficient to prepare ethylene and co-product hydrogen halide; (c) contacting the ethylene from process step (b) with a second source of halogen, and optionally, a second source of oxygen in the presence of a second oxidative halogenation catalyst under oxidative halogenation process conditions, and optional thermal cracking conditions, sufficient to prepare a vinyl halide monomer stream, wherein the resulting vinyl halide monomer stream may contain methyl chloride; (d) separating the vinyl halide monomer from any methyl chloride present to provide a vinyl halide stream comprising vinyl halide monomer or polyvinyl halide and a methyl halide stream; (e) optionally recycling the methyl halide from process step (d) to process step (b); and (f) optionally recycling the co-product hydrogen halide to process steps (a) and/or (c). In a related aspect of step (d), the vinyl halide monomer may be polymerized, if desired, to polyvinyl halide polymer, thereby effecting the separation of vinyl halide monomer from methyl halide. In this embodiment, the process produces polyvinyl halide as the final product.

The aforementioned process to prepare vinyl halide monomer or polymer may be practiced whereby both sources of halogen are hydrogen chloride, and oxygen is employed in process steps (a) and (c). In step (a), the rare earth halide or rare earth oxyhalide can be a rare earth chloride or rare earth oxychloride catalyst. In another embodiment, the rare earth is lanthanum or lanthanum in a mixture with other rare earth elements. The condensation catalyst can be selected from the group consisting of aluminosilicates of the DCM-2 and ZSM structure codes, aluminophosphates, borosilicates, silicates, and silicoaluminophosphates. In step (c) the second oxidative halogenation catalyst may also comprise the aforementioned rare earth halide or rare earth oxyhalide catalyst, being essentially free of iron and copper, with the proviso that when the catalyst contains cerium, the catalyst also contains at least one other rare earth element. In one embodiment, process steps (a) and (c) may occur simultaneously in a single reactor with the rare earth halide or rare earth oxyhalide catalyst.

In a more preferred respect of the aforementioned process, this invention is a method of manufacturing a vinyl chloride stream comprising vinyl chloride monomer or polyvinyl chloride, the process comprising the steps of: (a) generating a first reactor effluent stream by catalytically reacting together methane, oxygen, and at least one chlorine source to form methyl chloride; (b) condensing the methyl chloride to form ethylene and hydrogen chloride; (c) generating a second reactor effluent stream by catalytically reacting together the ethylene, oxygen, and at least one chlorine source in a reactor; (d) cooling and condensing said first reactor effluent stream to provide a raw product stream having a first portion of hydrogen chloride and a raw cooled hydrogen chloride stream having a second portion of hydrogen chloride; (e) separating said raw product stream into a vinyl chloride monomer product stream that optionally contains methyl chloride and into a lights stream having said first portion of the hydrogen chloride; (f) separating the first portion of hydrogen chloride from the lights stream to form a second lights stream; (g) recovering a first hydrogen chloride stream from the first portion of hydrogen chloride and conveying the first hydrogen chloride stream to a hydrogen chloride recovery subsystem; (h) conveying the raw cooled hydrogen chloride stream having the second portion of hydrogen chloride to a hydrogen chloride recovery subsystem; (i) recovering hydrogen chloride from the first hydrogen chloride stream and from the raw cooled hydrogen chloride stream having a second portion of hydrogen chloride; (j) optionally, sending the recovered hydrogen chloride to the reactor of step (a); (k) separating the vinyl chloride monomer and any methyl chloride from the vinyl chloride product stream to recover a vinyl chloride stream comprising vinyl chloride monomer or polyvinyl chloride. In a related aspect, the vinyl chloride monomer in the vinyl chloride product stream may be polymerized in step (k) to separate the monomer from methyl chloride. In one embodiment, the catalytically reacting steps (a) and (c) use a catalyst comprising a rare earth halide or rare earth oxyhalide, with the proviso that the catalyst is substantially free of iron and copper and with the further proviso that when the rare earth material component is cerium the catalyst further comprises at least one more rare earth material component other than cerium. In another embodiment, steps (a) and (c) can be combined in one reactor.

In another aspect, this invention is a process of preparing a vinyl halide stream comprising vinyl halide monomer or polyvinyl halide from methanol, the process comprising: (a) converting methanol to methyl halide; (b) contacting the methyl halide with a condensation catalyst under condensation conditions sufficient to prepare ethylene and co-product hydrogen halide; (c) contacting the ethylene from process step (b) with a source of halogen, and optionally, a source of oxygen in the presence of an oxidative halogenation catalyst under oxidative halogenation process conditions, and optional thermal cracking conditions, sufficient to prepare a vinyl halide monomer stream wherein the resulting vinyl halide monomer stream may contain methyl halide; (d) separating the vinyl halide monomer and any methyl halide to form a vinyl halide stream comprising vinyl halide monomer or polyvinyl halide, and recovering any methyl halide present; (e) optionally recycling the methyl halide from process step (d) to process step (b); and (f) optionally recycling the co-product hydrogen halide to process steps (a) and/or (c). In one embodiment, the methanol is formed by hydrolyzing methyl chloride that was prepared by contacting methane, oxygen, and a chlorine source in the presence of an oxidative halogenation catalyst under, the catalyst comprising a rare earth halide or rare earth oxyhalide being essentially free of iron and copper, with the proviso that when the catalyst contains cerium, the catalyst also contains at least one other rare earth element.

In one embodiment of the instant aforementioned process, a source of halogen for preparing methyl chloride and the source of halogen in process step (c) are both hydrogen chloride, and oxygen is employed in process steps (c). In one embodiment, the condensation catalyst is selected from the group consisting of aluminosilicates of the DCM-2 and ZSM structure codes, aluminophosphates, borosilicates, silicates, and silicoaluminophosphates. In one embodiment, in step (c) the oxidative halogenation catalyst comprises a rare earth halide or rare earth oxyhalide being essentially free of iron and copper, with the proviso that when the catalyst contains cerium, the catalyst also contains at least one other rare earth element. In another embodiment, the vinyl halide product stream containing vinyl halide monomer and methyl halide is subjected to polymerization so as to form polyvinyl halide, thereby facilitating separation step (d). In one embodiment, the process further comprises recovering cis/trans-1,2-dihaloethylene from the vinyl halide monomer stream and hydrogenating the recovered cis/trans-1,2-dihaloethylene to form 1,2-dihaloethane (1,2-ethylene dihalide).

In a preferred respect of the aforementioned process, this invention is a method of manufacturing a vinyl chloride stream comprising vinyl chloride monomer or polyvinyl chloride from methanol, the process comprising the steps of: (a) generating a first reactor effluent stream by converting methanol to methyl chloride; (b) condensing the methyl chloride to form ethylene; (c) generating a second reactor effluent stream by catalytically reacting together the ethylene, oxygen, and at least one chlorine source in a reactor to form vinyl chloride monomer and optionally methyl chloride; (d) cooling and condensing said second reactor effluent stream to provide a raw product stream having a first portion of hydrogen chloride and a raw cooled hydrogen chloride stream having a second portion of hydrogen chloride; (e) separating said raw product stream into a vinyl chloride monomer product stream that optionally contains methyl chloride and into a lights stream having said first portion of the hydrogen chloride; (f) separating the first portion of hydrogen chloride from the lights stream to form a second lights stream; (g) recovering a first hydrogen chloride stream from the first portion of hydrogen chloride and conveying the first hydrogen chloride stream to a hydrogen chloride recovery subsystem; (h) conveying the raw cooled hydrogen chloride stream having the second portion of hydrogen chloride to a hydrogen chloride recovery subsystem; (i) recovering hydrogen chloride from the first hydrogen chloride stream and from the raw cooled hydrogen chloride stream having a second portion of hydrogen chloride; (j) sending the recovered hydrogen chloride to the reactor of step (c); (k) separating the vinyl chloride monomer and any methyl chloride to form a vinyl chloride stream comprising vinyl chloride monomer or polyvinyl chloride. Optionally, in step (k) the vinyl chloride monomer may be polymerized to polyvinyl chloride to facilitate the separation step. In one embodiment, the catalytically reacting step (c) uses a catalyst comprising a rare earth material component, with the proviso that the catalyst is substantially free of iron and copper and with the further proviso that when the rare earth material component is cerium the catalyst further comprises at least one more rare earth material component other than cerium.

In another broad respect, this invention is an apparatus for making vinyl halide either as vinyl halide monomer or polyvinyl halide, comprising: (a) a first reactor that catalytically reacts together methane, oxygen, and at least one halogen source to form methyl halide; (b) a second reactor that condenses the methyl halide to form ethylene and hydrogen halide; (c) a third reactor that catalytically reacts together the ethylene, oxygen, and at least one halogen source to form vinyl halide monomer and optionally methyl halide; (d) a recovery subsystem for the recovery of hydrogen halide; (e) a separation subsystem that separates a stream containing the vinyl halide monomer and methyl halide; (f) optionally, a line that recycles the methyl halide to the second reactor, and (g) optionally, a line that recycles the hydrogen halide to the first and/or third reactors (a) and (c). Optionally, the separation subsystem (e) that separates the methyl halide from the vinyl halide monomer may comprise a polymerization reactor, such that polyvinyl halide is formed. In one embodiment, the first and third reactors are combined in a single reactor.

In another broad respect, this invention is an apparatus for making a vinyl halide stream comprising vinyl halide monomer or polyvinyl halide, comprising: (a) a first reactor that converts methanol to methyl halide; (b) a second reactor that condenses the methyl halide to form ethylene and hydrogen halide; (c) a third reactor that catalytically reacts together the ethylene, oxygen, and at least one halogen source to form vinyl halide monomer and optionally methyl halide; (d) a recovery subsystem for the recovery of hydrogen halide; (e) a separation subsystem that separates a stream containing the vinyl halide and any methyl halide present; (f) optionally, a line that recycles the methyl halide to the second reactor (b); and (g) optionally, a line that recycles the recovered hydrogen halide to the first and/or third reactors (a) and (c). Optionally, the separation subsystem (e) that separates the methyl halide from the vinyl halide monomer may comprise a polymerization reactor.

For any of the aspects of the inventions described hereinabove, in a most preferred embodiment, the source of halogen is hydrogen chloride; the vinyl halide is vinyl chloride; and the methyl halide is methyl chloride.

In the oxidative halogenation process steps of this invention, the source of halogen may be provided, for example, as elemental halogen or hydrogen halide. If the source is elemental halogen, then the halogen itself functions in a dual role to provide a halogen ion and an oxidation agent for the oxidative halogenation process. In this instance, the reaction products will include a halogen acid. Advantageously, the halogen acid can be recycled and used with a source of oxygen in the feed to effect the oxidative halogenation process steps. Accordingly, there is no need to regenerate elemental halogen from the product halogen acid.

In general, the source of halogen, which is employed in the process of this invention, may be any inorganic or organic halogen-containing compound that is capable of transferring its halogen atom(s) to the reactant hydrocarbon. Suitable non-limiting examples of the source of halogen include chlorine, bromine, iodine, hydrogen chloride, hydrogen bromide, hydrogen iodide, and halogenated hydrocarbons having one or more labile halogen substituents (that is, transferable halogen substituents), the latter typically being perhalocarbons or, preferably, halogenated hydrocarbons having typically two or more halogen atoms. Non-limiting examples of perhalocarbons with labile halogen substituents include carbon tetrachloride, carbon tetrabromide, and the like. Non-limiting examples of halogenated hydrocarbons having two or more halogen substituents, at least one substituent of which is labile, include chloroform, tribromomethane, dichloroethane, and dibromoethane. Preferably, the source of halogen is a source of chlorine or a source of bromine, more preferably, hydrogen chloride or hydrogen bromide, most preferably, hydrogen chloride.

The source of halogen may be provided to the oxidative halogenation process in any amount that is effective in producing the desired halogenated product. Typically, the amount of halogen source will vary depending upon the specific process stoichiometry, the reactor design, and safety considerations. It is possible, for example, to use a stoichiometric amount of halogen source with respect to the reactant hydrocarbon or with respect to oxygen, if oxygen is present. Alternatively, the source of halogen may be. used in an amount that is greater or less than the stoichiometric amount, if desired. In one embodiment illustrative of the invention, methane can be oxidatively chlorinated with chlorine to form methyl chloride and hydrogen chloride, the stoichiometric reaction of which is shown hereinbelow in Equation I:
CH₄+Cl₂→CH₃Cl+HCl (I)
The aforementioned process, which does not employ oxygen, is typically conducted fuel-rich, that is, with an excess of hydrocarbon reactant; but the process conditions are not limited to fuel-rich modes of operation. Other operating conditions outside the fuel-rich limits may also be suitable. Typically, the molar ratio of reactant hydrocarbon to source of halogen is greater than about 1/1, preferably, greater than about 2/1, and more preferably, greater than about 4/1. Generally, the molar ratio of reactant hydrocarbon to source of halogen is less than about 20/1, preferably, less than about 15/1, and more preferably, less than about 10/1.

In another illustrative embodiment of the invention, methane can be oxidatively chlorinated with hydrogen chloride in the presence of oxygen to produce methyl chloride and water, the stoichiometric reaction of which is shown hereinafter in Equation II:
CH₄+HCl+½O₂→CH₃Cl+H₂O (II)
This type of reaction, which employs oxygen, is usually conducted “fuel-rich,” due to safety considerations. In this instance, the term “fuel-rich” means that oxygen is the limiting reagent and a molar excess of C₁ reactant hydrocarbon is used relative to oxygen. Typically, for example, the molar ratio of hydrocarbon to oxygen is chosen for operation outside the fuel-rich flammability limit of the mixture, although this is not absolutely required. In addition, a stoichiometric (for example, 1 HCl:0.5 O₂) or greater than stoichiometric molar ratio of hydrogen halide to oxygen is typically employed to maximize the yield of halogenated hydrocarbon product.

The reactant hydrocarbon used in the oxidative halogenation process of this invention comprises methane, which can be provided to the oxidative halogenation process as a pure feed stream, or diluted with an inert diluent as described hereinafter.

A source of oxygen is not required for the oxidative halogenation process of this invention; however, it is preferred to use a source of oxygen, particularly when the source of halogen contains hydrogen atoms. The source of oxygen can be any oxygen-containing gas, such as, essentially pure molecular oxygen, air, oxygen-enriched air, or a mixture of oxygen with a diluent gas, such as nitrogen, argon, helium, carbon monoxide, carbon dioxide, and mixtures thereof. As noted above, when oxygen is employed, the feed to the oxidative halogenation reactor is generally fuel-rich. Typically, the molar ratio of reactant C₁ hydrocarbon (methane) to oxygen is greater than about 2/1, preferably, greater than about 4/1, and more preferably, greater than about 5/1. Typically, the molar ratio of reactant C₁ hydrocarbon (methane) to oxygen is less than about 20/1, preferably, less than about 15/1, and more preferably, less than about 10/1.

Based on the description hereinabove, one skilled in the art will know how to determine the molar quantities of reactant C₁ hydrocarbon, source of halogen, and source of oxygen suitable for reactant combinations different from those illustrated hereinabove.

Optionally, if desired, the feed, comprising reactant hydrocarbon, source of halogen, and preferred source of oxygen, can be diluted with a diluent or carrier gas, which may be any essentially non-reactive gas that does not substantially interfere with the oxidative halogenation process. The diluent may assist in removing products and heat from the reactor and in reducing the number of undesirable side-reactions. Non-limiting examples of suitable diluents include nitrogen, argon, helium, carbon monoxide, carbon dioxide, and mixtures thereof. The quantity of diluent employed is typically greater than about 10 mole percent, and preferably, greater than about 20 mole percent, based on the total moles of feed to the reactor, that is, total moles of reactant hydrocarbon, source of halogen, source of oxygen, and diluent. The quantity of diluent employed is typically less than about 90 mole percent, and preferably, less than about 70 mole percent, based on the total moles of feed to the reactor.

The catalyst employed in the oxidative halogenation process of this invention to form methyl chloride comprises, in one aspect, a rare earth halide compound. The rare earths are a group of 17 elements consisting of scandium (atomic number 21), yttrium (atomic number 39) and the lanthanides (atomic numbers 57-71) [James B. Hedrick, U.S. Geological Survey—Minerals Information—1997, “Rare-Earth Metals”]. Preferably, herein, the term is taken to mean an element selected from lanthanum, cerium, neodymium, praseodymium, dysprosium, samarium, yttrium, gadolinium, erbium, ytterbium, holmium, terbium, europium, thulium, lutetium, and mixtures thereof. Preferred rare earth elements for use in the aforementioned oxidative halogenation process are those that are typically considered as being single valency metals. The catalytic performance of rare earth halides using multi-valency metals appears to be less desirable than those using single valency metals. The rare earth element for this invention is preferably selected from lanthanum, neodymium, praseodymium, dysprosium, yttrium, and mixtures thereof. Most preferably, the rare earth element used in the catalyst is lanthanum or a mixture of lanthanum with other rare earth elements.

Preferably, the rare earth halide is represented by the formula MX₃ wherein M is at least one rare earth element selected from the group consisting of lanthanum, cerium, neodymium, praseodymium, dysprosium, samarium, yttrium, gadolinium, erbium, ytterbium, holmium, terbium, europium, thulium, lutetium, and mixtures thereof; and wherein X is chloride, bromide, or iodide. More preferably, X is chloride, and the more preferred rare earth halide is represented by the formula MCl₃, wherein M is defined hereinbefore. Most preferably, X is chloride, and M is lanthanum or a mixture of lanthanum with other rare earth elements.

In a more preferred embodiment of this invention, the rare earth halide or rare earth oxyhalide catalyst is “porous,” which, for the purposes of this invention, means that the catalyst has a surface area of least about 3 m²/g, as determined by the BET (Brunauer-Emmet-Teller) method of measuring surface area, described by S. Brunauer, P. H. Emmett, and E. Teller, Journal of the American Chemical Society, 60,309 (1938). In another more preferred embodiment of this invention, the rare earth halide is lanthanum chloride, and the rare earth oxyhalide is lanthanum oxychloride.

In a preferred embodiment, the rare earth halide is porous, meaning that typically the rare earth halide has a BET surface area of greater than 3 m²/g, preferably, greater than 5 m²/g. More preferably, the BET surface area is greater than 10 m²/g, even more preferably, greater than 15 m²/g,. For these above measurements, a nitrogen adsorption isotherm was measured at 77K and the surface area was calculated from the isotherm data utilizing the BET method, as referenced earlier herein.

In another aspect, the catalyst employed in this invention comprises a rare earth oxyhalide, the rare earths being the seventeen elements identified hereinabove. Preferably, the rare earth oxyhalide is represented by the formula MOX, wherein M is at least one rare earth element selected from the group consisting of lanthanum, cerium, neodymium, praseodymium, dysprosium, samarium, yttrium, gadolinium, erbium, ytterbium, holmium, terbium, europium, thulium, lutetium, and mixtures thereof; and wherein X is selected from the group consisting of chloride, bromide, and iodide. More preferably, the rare earth halide is a rare earth oxychloride, represented by the formula MOCl, wherein M is defined hereinbefore. Most preferably, M is lanthanum or lanthanum with a mixture of other rare earth elements.

In a preferred embodiment, the rare earth oxyhalide is also porous, which generally implies a BET surface area of greater than about 12 m²/g. Preferably, the rare earth oxyhalide has a BET surface area of greater than about 15 m²/g. Generally, the BET surface area of the rare earth oxyhalide is less than about 200 m²/g. In addition, it is noted that the MOCl phases possess characteristic powder X-Ray Diffraction (XRD) patterns that are distinct from the MCl₃ phases.

In general, the presence in the catalyst of metals that are capable of oxidation-reduction (redox) is undesirable. Redox metals typically include transition metals that have more than one stable oxidation state, such as iron, copper, and manganese. The rare earth halide or oxyhalide catalyst of this invention is specifically required to be substantially free of copper and iron. The term “substantially free” means that the atom ratio of rare earth element to redox metal, preferably iron or copper, is greater than about 1/1, preferably greater than about 10/1, more preferably greater than about 15/1, and most preferably greater than about 50/1. In addition, cerium, a lanthanide rare earth element, is known to be an oxidation-reduction catalyst having the ability to access both the 3⁺and 4⁺oxidation states. For this reason, if the rare earth metal is cerium, the catalyst of this invention further comprises at least one more rare earth metal other than cerium. Preferably, if one of the rare earth metals is cerium, the cerium is provided in a molar ratio that is less than the total amount of other rare earth metals present in the catalyst. More preferably, however, substantially no cerium is present in the catalyst. By “substantially no cerium” it is meant that any cerium present is in an amount less than about 10 atom percent, preferably, less than about 5 atom percent, and even more preferably, less than about 1 atom percent of the total rare earth components.

In an alternative embodiment of this invention, the rare earth halide or rare earth oxyhalide catalyst, described hereinbefore, may be bound to, extruded with, or deposited onto a catalyst support, such as alumina, silica, silica-alumina, porous aluminosilicate (zeolite), silica-magnesia, bauxite, magnesia, silicon carbide, titanium oxide, zirconium oxide, zirconium silicate, or any combination thereof. In this embodiment, the conventional support is used in a quantity greater than about 1 weight percent, but less than about 90 weight percent, preferably, less than about 70 weight percent, more preferably, less than about 50 weight percent, based on the total weight of the catalyst and catalyst support.

It may also be advantageous to include other elements within the catalyst. For example, preferable elemental additives include alkali and alkaline earths, preferably, calcium, as well as boron, phosphorous, sulfur, germanium, titanium, zirconium, hafnium, and combinations thereof. These elements can be present to alter the catalytic performance of the composition or to improve the mechanical properties (for example attrition-resistance) of the material. In one preferred embodiment, the elemental additive is calcium.

In another preferred embodiment, the elemental additive is not aluminum or silicon. The total concentration of elemental additives in the catalyst is typically greater than about 0.01 weight percent and typically less than about 20 weight percent, based on the total weight of the catalyst.

Rare earth halides and rare earth oxyhalides may be obtained commercially or prepared by methods published in the art. For porous forms of the rare earth oxyhalide (MOX), a preferred method of preparation comprises the following steps: (a) preparing a solution of a halide salt of the rare earth element or elements in a solvent comprising either water, an alcohol, or mixtures thereof; (b) adding a base to cause the formation of a precipitate; and (c) collecting and calcining the precipitate in order to form the MOX. Preferably, the halide salt is a rare earth chloride salt, for example, any commercially available rare earth chloride. Typically, the base is a nitrogen-containing base selected from ammonium hydroxide, alkyl amines, aryl amines, arylalkyl amines, alkyl ammonium hydroxides, aryl ammonium hydroxides, arylalkyl ammonium hydroxides, and mixtures thereof. The nitrogen-containing base may also be provided as a mixture of a nitrogen-containing base with other bases that do not contain nitrogen. Preferably, the nitrogen-containing base is ammonium hydroxide or tetra(alkyl)ammonium hydroxide, more preferably, tetra(C₁₋₂₀ alkyl)ammonium hydroxide. Porous rare earth oxychlorides may also be produced by appropriate use of alkali or alkaline earth hydroxides, particularly, with the buffering of a nitrogen-containing base, although caution should be exercised to avoid producing substantially the rare earth hydroxide or oxide. The solvent in Step (a) is preferably water. Generally, the precipitation is conducted at a temperature greater than about 0° C. Generally, the precipitation is conducted at a temperature less than about 200° C., preferably, less than about 100° C. The precipitation is conducted generally at about ambient atmospheric pressure, although higher pressures may be used, as necessary, to maintain liquid phase at the precipitation temperature employed. The calcination is typically conducted at a temperature greater than about 200° C., preferably, greater than about 300° C., and less than about 800° C., preferably, less than about 600° C. Production of mixed carboxylic acid and rare earth chloride salts also can yield rare earth oxychlorides upon appropriate decomposition.

For porous forms of the rare earth halide (MX₃), a preferred method of preparation comprises the following steps: (a) preparing a solution of a halide salt of the rare earth element or elements in a solvent comprising either water, an alcohol, or mixtures thereof; (b) adding a base to cause the formation of a precipitate; (c) collecting, washing and calcining the precipitate; and (d) contacting the calcined precipitate with a halogen source. Preferably, the rare earth halide is a rare earth chloride salt, such as any commercially available rare earth chloride. The solvent and base may be any of those mentioned hereinbefore in connection with the formation of MOX. Preferably, the solvent is water, and the base is a nitrogen-containing base. The precipitation is generally conducted at a temperature greater than about 0° C. and less than about 200° C., preferably less than about 100° C., at about ambient atmospheric pressure or a higher pressure so as to maintain liquid phase. The calcination is typically conducted at a temperature greater than about 200° C., preferably, greater than about 300° C., but less than about 800° C., and preferably, less than about 600° C. Preferably, the halogen source is a hydrogen halide, such as hydrogen chloride, hydrogen bromide, or hydrogen iodide. More preferably, the halogen source is hydrogen chloride. The contacting with the halogen source is typically conducted at a temperature greater than about 100° C. and less than about 500° C. Typical pressures for the contacting with the source of halogen range from about ambient atmospheric pressure to pressures less than about 150 psia (1,034 kPa).

As noted hereinabove, the rare earth oxyhalide (MOX) compound can be converted into the rare earth halide (MX₃) compound by treating the oxyhalide with a source of halogen. Since the oxidative halogenation process of this invention requires a source of halogen, it is possible to contact the rare earth oxyhalide with a source of halogen, such as chlorine or hydrogen chloride, in the oxidative halogenation reactor to form the MX3 catalyst in situ .

The oxidative halogenation process of this invention can be conducted in a reactor of any conventional design suitable for gas phase processes, including batch, fixed bed, fluidized bed, transport bed, continuous and intermittent flow reactors, and catalytic distillation reactors. The process conditions (for example, molar ratio of feed components, temperature, pressure, gas hourly space velocity), can be varied widely, provided that the desired halogenated C₁ hydrocarbon product, preferably monohalogenated C₁ hydrocarbon product, more preferably, methyl chloride, is obtained. Typically, the process temperature is greater than about 200° C., preferably, greater than about 300° C., and more preferably, greater than about 350° C. Typically, the process temperature is less than about 600° C., preferably, less than about 500° C., and more preferably, less than about 450° C. Ordinarily, the process can be conducted at atmospheric pressure; but operation at higher or lower pressures is possible, as desired. Preferably, the pressure is equal to or greater than about 14 psia (97 kPa), but less than about 150 psia (1,034 kPa). Typically, the total weight hourly space velocity (WHSV) of the feed (reactant hydrocarbon, source of halogen, optional source of oxygen, and optional diluent) will be greater than about 0.1 gram total feed per g catalyst per hour (h⁻¹), and preferably, greater than about 0.5 h⁻¹. Typically, the total gas hourly space velocity of the feed will be less than about 100 h⁻¹, and preferably, less than about 20 h⁻¹.

If the oxidative halogenation process is conducted as described hereinabove, then a halogenated C₁ hydrocarbon product is formed that has a greater number of halogen substituents as compared with the reactant hydrocarbon. Halogenated C₁ hydrocarbon products beneficially produced by the oxidative halogenation process of this invention include, without limitation, methyl chloride, dichloromethane, methyl bromide, dibromomethane, methyl iodide, chloroform, and tribromomethane. Preferably, the halogenated C₁ hydrocarbon product is a monohalogenated C₁ hydrocarbon, a dihalogenated C₁ hydrocarbon, or a combination thereof. More preferably, the halogenated C₁ hydrocarbon product is a monohalogenated C₁ hydrocarbon. Even more preferably, the halogenated C₁ hydrocarbon product is methyl chloride or methyl bromide; most preferably, methyl chloride.

For the oxidative halogenation process, “conversion” shall be defined as the mole percentage of reagent that is converted in the oxidative halogenation process of this invention into product(s). Reference may be made to “conversion of reactant hydrocarbon,” or “conversion of source of halogen,” or “oxygen conversion.” Conversions will vary depending upon the specific reactant, specific catalyst, and specific process conditions. Typically, for the process of this invention, the conversion of methane is greater than about 3 mole percent, and preferably, greater than about 10 mole percent. Typically, for the process of this invention, the conversion of the source of halogen is greater than about 12 mole percent, and preferably, greater than about 20 mole percent. Typically, the oxygen conversion is greater than about 10 mole percent, and preferably, greater than about 20 mole percent.

For the oxidative halogenation process, “selectivity” shall be defined as the mole percentage of converted methane that is converted into a specific product, such as a halogenated C₁ hydrocarbon product or oxygenated by-product, such as CO or CO₂. In the oxidative halogenation process of this invention, the selectivity to monohalogenated C₁ hydrocarbon product, most preferably, methyl chloride or methyl bromide, is typically greater than about 60 mole percent, preferably, greater than about 70 mole percent, and more preferably, greater than about 80 mole percent. The selectivity to dihalogenated C₁ hydrocarbon product, preferably dichloromethane or dibromomethane, is typically less than about 20 mole percent, and preferably, less than about 15 mole percent. Advantageously, the oxidative halogenation process of this invention produces essentially no perhalogenated product, such as, carbon tetrachloride or carbon tetrabromide, which have lower commercial value. As a further advantage, in preferred embodiments low levels of oxygenated by-products, such as COₓ oxygenates (CO and CO₂) are produced. Typically, the total selectivity to carbon monoxide and carbon dioxide is less than about 20 mole percent, preferably, less than about 15 mole percent, and more preferably, less than about 10 mole percent.

The monohalogenated hydrocarbon product, preferably, methyl chloride or methyl bromide, that is produced in the oxidative halogenation process can be utilized as a feed in downstream processes that produce high-value commodity chemicals, such as methyl alcohol, dimethyl ether, light olefins, including ethylene, propylene, and butenes; higher hydrocarbons, including C5+ gasolines; vinyl halide monomer, and acetic acid. The hydrolysis of methyl halides to form methyl alcohol has been previously described in the art, representative citations of which include U.S. Pat. Nos. 1,086,381, 4,990,696, 4,523,040, 5,969,195, and as disclosed by G. Olah in Journal of the American Chemical Society, 1985, 107, 7097-7105, and I. Fells, Fuel Society Journal, 10, 1959, 26-35. For the example of methyl chloride hydrolysis to methyl alcohol, the process can be represented by the following stoichiometric reaction (III):
CH₃Cl+H₂O→CH₃OH+HCl (III)
Any catalyst can be employed for the hydrolysis, provided that the hydrolysis produces methyl alcohol. Many catalysts exhibit activity for this hydrolysis including, for example, alumina; various zeolites of the ZSM structure code, such as ZSM-5, preferably, having a Constraint Index from 1 to 12; alkali and alkaline earth metal hydroxides and alkoxides, such as sodium hydroxide, potassium hydroxide, and sodium ethoxide; alkyl ammonium hydroxides and various amines, for example, trimethylamine hydroxide and piperidine; transition metal halide complexes, preferably, halide complexes of platinum, palladium, and nickel, and mixtures thereof, more preferably, the chloride complexes thereof, optionally including a cation of H⁺, Group IA, or Group IIA elements, such as K⁺or Na⁺; and metal oxide/hydroxide catalysts, including the metal oxides/hydroxides of Group IIA elements (for example, Mg, Ba), the entire series of transition elements (for example, V, Cr, Zr, Ti, Fe, or Zn), supported on γ-alumina or activated carbon.

The hydrolysis process conditions can vary depending upon the particular catalyst and methyl halide employed. Since the thermodynamics favor the reverse reaction to form methyl halide (that is, Equation III in reverse), an excess of water relative to methyl halide is typically employed to drive the equilibrium towards methyl alcohol. Preferably, the molar ratio of water to methyl halide is greater than about 1:1, more preferably, greater than about 5:1. Preferably, the water/methyl halide molar ratio is less than about 20:1, more preferably, less than about 10:1. Generally, the hydrolysis is conducted at a temperature greater than about 85° C., and preferably, greater than about 115° C. Generally, the hydrolysis is conducted at a temperature less than about 600° C., and preferably, less than about 400° C. The process pressure can also vary from subatmospheric to superatmospheric; but generally ranges from greater than about 7 psia (50 kPa), and preferably, greater than about 14 psia (97 kPa), to less than about 725 psia (4,999 kPa), and preferably, less than about 73 psia (500 kPa). The weight hourly space velocity (WHSV) of the methyl halide feed can vary widely from a value typically greater than about 0.1 g feed per g catalyst per hour (h⁻¹) to a value less than about 1,000 h⁻¹. Preferably, the weight hourly space velocity of the methyl halide feed ranges from greater than about 1 h⁻¹ to less than about 10 h⁻¹.

The conversion of methyl halide, that is, the molar percentage of methyl halide reacted relative to methyl halide in the feed, will vary depending upon the specific catalyst and process conditions. Generally, methyl alcohol and dimethyl ether comprise the predominant products, in varying ratios depending upon the catalyst and process conditions. Further details of the hydrolysis process and product distribution can be found in the pertinent references cited hereinabove. Hydrogen halide, which is a co-product of the hydrolysis process, can be conveniently recycled to the oxidative halogenation reactor, where it can be consumed as a source of halogen.

In another aspect of this invention, the methyl halide prepared by the aforementioned oxidative halogenation of methane can be condensed to form light olefins, such as ethylene, propylene, butenes, and higher hydrocarbons, including C₅₊gasolines. For the example of methyl chloride being converted into ethylene, the stoichiometric reaction can be represented by the following Equation (IV):
2CH₃Cl→CH₂=CH₂+2HCl (IV)
As seen from the above, hydrogen halide, such as hydrogen chloride, is produced as a co-product product of this condensation process. Again, the hydrogen halide can be conveniently recycled to the oxidative halogenation reactor and consumed as a source of halogen.

Any catalyst capable of effecting the condensation process can be employed. U.S. Pat. No. 5,397,560, for example, discloses the use of aluminosilicates having a DCM-2 structure code for the conversion of methyl halides into light olefins, predominantly ethylene and propylene. Catalysts known for the condensation of methyl alcohol to light olefins and gasolines can also be employed analogously for the condensation described herein of methyl halides into light olefins and gasolines. Non-limiting examples of such catalysts include zeolites of the ZSM structure code, such as ZSM-5, ZSM-11, ZSM-12, ZSM-34, ZSM-35, and ZSM-38, preferably, wherein the aforementioned ZSM zeolite has a Constraint Index from 1 to 12; as well as various aluminophosphates (ALPO's) and silicoaluminophosphates (SAPO's). References disclosing one or more of the aforementioned catalysts include U.S. Pat. Nos. 3,894,107, 4,480,145, 4,471,150, 4,769,504, 5,912,393.

Generally, the condensation process involves contacting methyl halide with the catalyst under condensation process conditions sufficient to prepare at least one light olefin, such as ethylene, propylene, butenes, or at least one C₅₊hydrocarbon, or any mixture thereof. Preferably, ethylene is produced. The process temperature typically is greater than about 250° C., and preferably, greater than about 350° C. The process temperature is typically less than about 600° C., and preferably, less than about 450° C. The process pressure can vary from subatmospheric to superatmospheric; but generally a pressure greater than about 0.1 psi absolute (689 Pa) and less than about 300 psi absolute (2,068 kPa) is employed. The weight hourly space velocity (WHSV) of the methyl halide feed can vary widely from a value typically greater than about 0.1 g feed per g catalyst per hour (h⁻¹) to a value less than about 1,000 h⁻¹. Preferably, the weight hourly space velocity of the methyl halide feed ranges from greater than about 1 h⁻¹ to less than about 10 h⁻¹. The product distribution of the aforementioned condensation process will vary depending upon the specific feed, catalyst, and process conditions. A product stream comprising light olefins, predominantly ethylene, propylene, and butenes, is generally obtained with the DCM-2 catalyst. A product stream containing predominantly heavier hydrocarbons, such as C₅₊gasolines, is generally obtained with zeolite ZSM catalysts. Again, the hydrogen halide, obtained as a co-product of the process, can be conveniently recycled to the oxidative halogenation reactor and consumed as a source of halogen.

In a further application of this invention, ethylene obtained from the condensation of methyl halide can be fed directly into a vinyl halide monomer process, wherein the ethylene is contacted with a source of halogen, preferably the hydrogen halide, and optionally, a source of oxygen in the presence of an oxidative halogenation catalyst. Preferably, a source of oxygen is used. For the purposes of making vinyl halide monomer, the source of halogen and the source of oxygen can be any of those sources of halogen and sources of oxygen described hereinbefore in connection with the oxidative halogenation of methane. For the purposes of preparing vinyl halide monomer, the oxidative halogenation catalyst can be any conventional catalyst known for such a purpose, including supported copper catalysts, such as, supported copper chloride promoted with alkali or alkaline earth halides, known to those skilled in the art. When these conventional catalysts are used, then dihaloethane is obtained, which is subsequently thermally cracked to vinyl halide monomer. In a preferred embodiment, the oxidative halogenation catalyst is the rare earth halide or rare earth oxyhalide catalyst described hereinbefore in connection with the oxidative halogenation of methane. When the rare earth halide is used, then vinyl halide monomer is obtained directly without the need for a separate thermal cracking reactor. Vinyl halide monomer can also be made by mixing ethylene with the methane feed to the methane oxidative halogenation reactor so as to obtain an effluent containing both methyl halide and vinyl halide monomer. Separation of methyl halide and vinyl halide monomer prior to conversion of the methyl halide to ethylene beneficially provides a two-reactor system of producing vinyl halide from methane. Depending upon the design of the separation step, the vinyl halide product stream may comprise vinyl halide monomer or polyvinyl halide.

Typically, in the oxidative halogenation of ethylene, the molar ratio of ethylene to oxygen is greater than about 2/1, preferably, greater than about 4/1, and generally, less than about 20/1, and preferably, less than about 15/1. Generally, the oxidative halogenation of ethylene is carried out at a temperature greater than about 150° C., preferably, greater than about 200° C., and more preferably, greater than about 250° C. Typically, the oxidative halogenation of ethylene is carried out at a temperature less than about 500° C., preferably, less than about 425° C., and more preferably, less than about 350° C. Ordinarily, the process will be conducted at atmospheric pressure or a higher pressure. Typically, then, the pressure will be equal to or greater than about 14 psia (101 kPa), but less than about 150 psia (1,034 kPa). Typically, the total gas hourly space velocity (GHSV) of the reactant feed (ethylene, source of halogen, source of oxygen, and any optional diluent) will vary from greater than about 10 ml total feed per ml catalyst per hour (h⁻¹), preferably, greater than about 100 h⁻¹, to less than about 50,000 h⁻¹, and preferably, less than about 10,000 h⁻¹. Further details on catalyst and process conditions suitable for the oxidative halogenation of ethylene-containing streams to vinyl halide monomer can be found in PCT international application, Serial No. PCT/US00/27272, (Dow Case No. 44649), filed on Oct. 3, 2002, to Mark E. Jones, Michael M. Olken, and Daniel A. Hickman, entitled “A PROCESS FOR THE CONVERSION OF ETHYLENE TO VINYL CHLORIDE, AND NOVEL CATALYST COMPOSITIONS USEFUL FOR SUCH PROCESS.”

Referring now to FIG. 1, there is shown an overall process flow scheme for the conversion of methane to a vinyl halide, particularly vinyl chloride monomer and polyvinyl chloride. In this scheme, methane, oxygen, and one or more sources of chlorine (such as chlorine, hydrogen chloride, and chlorinated hydrocarbons) are fed via representative feed lines 101-104 and 182 to Oxidative Chlorination Reactor 110, which contains the rare earth catalyst described hereinbefore. Feed line 101 delivers methane. Feed line 102 delivers oxygen. Feed line 103 delivers chlorine. Feed line 182 optionally delivers ethyl chloride recycle. Feed line 104 optionally delivers hydrogen chloride. Likewise, ethylene and HCl from Methyl Chloride Conversion Reactor 120 are simultaneously fed to the Oxidative Chlorination Reactor 110 via feed line 121.

The methyl chloride that is employed in Methyl Chloride Conversion Reactor 120 is formed in Oxidative Chlorination Reactor 110 from the methane that is converted to methyl chloride. Simultaneously in Reactor 110 ethylene, produced in Methyl Chloride Conversion Reaction 120 fed through Feed line 121, reacts with a chlorine source to form vinyl chloride monomer. The Oxidative Chlorination Reactor 110 and Methyl Chloride Conversion Reactor 120 may be of conventional design, and employ catalyst and process conditions such as described hereinabove.

The effluent from Oxidative Chlorination Reactor 110 is conveyed via effluent line 112 to Cool & Condenser 130. In Cool & Condenser 130, the effluent is treated to provide a raw product (vapor) stream as effluent stream 132, which is fed to a Product Split 140, and a raw cooled (aqueous) hydrogen chloride stream as effluent stream 131. The raw cooled hydrogen chloride aqueous stream 131 is treated in Phase Separation Subsystem 150 to remove residual organic compounds. The Phase Separation Subsystem may comprise a variety of conventional apparatus used for this purpose in the industry. The residual organic vapor compounds from the phase separation subsystem 150 are conveyed to Product Split 140 via line 151, with the separated raw cooled (essentially aqueous liquid) HCl being sent to the Anhydrous HCl Recovery Subsystem 160. Additional aqueous HCl is introduced to the HCl Recovery Subsystem 160 via line 161 and can include material from HCl Absorption unit 210 and any aqueous stream the site may provide. Water exits the HCl Recovery Subsystem 160 via line 162. Recovered HCl (anhydrous) is recycled to the Reactor 110 via line 163, which feeds into HCl delivery line 104 to Reactor 110. It should be appreciated that Anhydrous HCl Recovery Subsystem 160 provides functionality to recover an anhydrous hydrogen chloride stream from the raw cooled hydrogen chloride stream 152 and other aqueous HCl streams from the Reactor 110. Anhydrous HCl Recovery Subsystem 160 also provides recycle anhydrous hydrogen chloride (vapor) to the Oxidative Chlorination reactor 110. Typically, the HCl Recovery Subsystem 160 employs a distillation process to recover the anhydrous HCl from the aqueous HCl streams. As should be apparent to those of skill, there are other methodologies for separating anhydrous HCl from mixtures of water and HCl.

Referring again to Product Split 140, the vapor streams of effluent lines 132 and 151, obtained from Cool & Condenser 130 and Phase Separation Subsystem 150, respectively, are treated typically by distillation in Product Split 140. The resulting lights streams from Product Split 140 contains ethylene and may include other components, and exits via line 141. The balance of the effluent from Product Split 140, which contains methyl chloride, VCM, and may contain other components, is forwarded via effluent line 142 for separation in series to the Drying Subsystem 170, VCM Purification unit 180, and EDC Purification unit 190. The manner of effecting these final separations is apparent to those of skill in the art and a substantial number of classic process units can be deployed in various configurations to achieve the separations. Sequentially connected Drying Subsystem 170, VCM Purification unit 180, and EDC Purification unit 190 conveniently depict, therefore, the general separation systems for separation of Water Stream 171, VCM and methyl chloride Product Stream 181, Ethyl Chloride Stream 182, Cis/trans-1,2-dichloroethylene Stream 191, and 1,2-Dichloroethane (EDC) Stream 192, with Heavies Stream 193 as organic material for destruction in a waste organic burner or use in an appropriate product where the general properties of Heavies Stream 193 are acceptable. In an alternative contemplated embodiment, Drying Subsystem 170 removes water prior to Product Split 140, with the effluent from Product Split 140 being forwarded to VCM Purification unit 180.

The lights stream from Product Split 140, which contains ethylene and methyl chloride and may include other components such as methane and optionally oxygen, that exited via line 141 is split with a portion recycled to Reactor 110 via line 143 and a portion sent to HCl Absorption Subsystem 210 via Lights line 144. In the HCl Absorption Subsystem 210, an absorber may be used to removed trace amounts of HCl from the gaseous compounds and return the HCl to HCl Recovery Subsystem 160 such as through line 161. Additional aqueous HCl available on the site may also be introduced into line 161. The HCl-stripped stream, exiting the HCl Absorption Subsystem via line 211, is fed to C2 Recovery Absorption and Stripping Columns 220 (C2 Absorption and Stripping Columns is optional, and the stream from HCl Absorption Subsystem 210 may be sent directly to Vent Treatment Unit 230). In C2 Absorption and Stripping Columns 220, light materials such as ethylene are absorbed and stripped , then recycled via line 221 to the Oxidative Chlorination reactor 110 and/or to the HCl Absorption Subsystem 210, if there is a split in the line. If the system is operated using air as the source of oxygen, the split streams to the Reactor 110 could be omitted (no recycle) as the C₁ and C₂ hydrocarbon reactants could be reacted to extinction, with C2 Absorption and Stripping Columns 220 also optionally being omitted. The C2 Absorption and Stripping Columns 220 is of conventional design and operated as is typical in the industry for these types of materials. The stripped stream exits C2 Absorption and Stripping Columns.220 via line 222 to Vent Treatment Unit 230 for disposal, such as through oxidation to carbon dioxide and any carbon monoxide, which is vented via line 231.

The VCM product stream that may contain methyl chloride, which exits VCM Purification 180, may be separated by any method known to the skilled artisan to recover the methyl chloride and provide an essentially purified vinyl chloride stream. The vinyl chloride stream may contain vinyl chloride monomer or polyvinyl chloride, depending upon the separation unit. In one preferred separation embodiment, as shown in FIG. 1, the VCM/methyl chloride stream that exits VCM Column 180 is sent via line 181 to VCM Polymerization Reactor 200. In VCM Polymerization Reactor 200, the VCM is polymerized using standard methods to form polyvinyl chloride, which exits via line 202.

Unreacted, gaseous methyl chloride may be recovered from the polymerization reactor using standard techniques and sent to Methyl Conversion Unit 120 via line 201 for condensation to ethylene, which itself is sent via line 121 to Oxidative Chlorination reactor 110.

In the process of this invention, the flow rates of the reactants in the various unit operations vary depending on conditions, and are readily determined by one of skill in the art.

In FIG. 2 there is illustrated an alternative embodiment of this invention where methane is employed in the manufacture of vinyl chloride, as vinyl chloride monomer and polyvinyl chloride. In FIG. 2, the scheme is the same as that depicted in FIG. 1 with the following modifications. First, methane is not provided to Reactor 110. Reactor 110 serves solely to convert ethylene obtained from Feed line 121 to VCM. The methane is instead fed via feed line 101 to Reactor 100. Reactor 100 is the same type of reactor as Reactor 110 and contains the same type of catalyst. In this embodiment, accordingly, the methyl chloride is formed in a separate reactor instead of simultaneous production with the VCM. The Reactor 100 is also fed oxygen via Feed line 102, and HCl from HCl Recovery Subsystem 160 via Feed line 163. Methyl chloride exiting Oxidative Chlorination Reactor 100 is fed via effluent line 164 to Methyl Conversion Unit 120. There may be unreacted 20 methyl chloride which flows out of Reactor 110, which is separated downstream in VCM Polymerization Reactor 200 and recycled via line 201 to Methyl Conversion Unit 120.

Turning to FIG. 3, there is illustrated a process scheme for the formation of vinyl halide as vinyl halide monomer and polyvinyl halide starting from methanol. For purposes of this Figure, the halide is chloride. The methanol may be obtained conventionally, or may be manufactured by hydrolyzing methyl chloride that was made using the methane oxidative chlorination process disclosed herein. The process of FIG. 3 is identical to FIG. 1 with the following modifications. First, methyl chloride is made by feeding methanol via methanol feed line 241 and HCl via HCl feed line 163 to Hydrochlorination Unit 240 to thereby form methyl chloride, which is sent via methyl chloride feed line 243 to Methyl Conversion Unit 120, and with water exiting the Hydrochlorination Unit 240 via line 242. The so-formed methyl chloride is conveyed to Methyl Conversion Unit 120 via line 243 together with any methyl chloride recycled via line 201. Secondly, Reactor 110 is fed ethylene from Methyl Conversion Unit 120, but methane is not fed to Reactor 110.

Ethane may optionally be fed to Reactor 110 via line 106, but the process can be practiced without the addition of ethane to Reactor 110. All other steps in FIG. 3 are operated as per FIG. 1 with appropriate changes that would be appreciated to one of skill in the art.

FIG. 4 is identical to FIG. 3 except that the cis/trans-1,2-dichloroethylene and optionally 1,2-dichloroethane (EDC) that is recovered from EDC Purification 190 is conveyed to Hydrogenation Unit 250 via line 191. Operation of the EDC Purification Unit 190 may produce a purified EDC stream 192 in addition to the mixed EDC and 1,2-dichloroethylenes stream 191. EDC stream 192 may optionally be split off and sent directly, for instance, to the Reactor 110, as shown in both FIGS. 3 and 4 via lines 192 and 252. Stream 191 of FIG. 4, containing both cis/trans-1,2-dichloroethylene and optionally 1,2-dichloroethane (EDC), is sent to Hydrogenation unit 250 where hydrogen is fed via hydrogen line 251 to hydrogenate the 1,2-dichloroethylene to 1,2-dichloroethane (ethylene dichloride, EDC). The EDC can be sold, used for another process, or recycled to Reactor 110 as a source of chlorine.

Table A presents further detail in components identified in the Figures. While the description is presented for the preferred oxidative chlorination apparatus and associated chloride products, one skilled in the art will appreciate that the process can be applied more broadly to other specie embodiments of said oxidative halogenation processes and halide products.

TABLE A
Component Detail

| Drawing | | |
|---|---|---|
| Element | Name | Description |
| 110 | Oxidative | Ethylene and/or methane oxidative chlorination reactor. A |
| | Halogenation | fluid bed version (preferred) of the reactor is a vertically |
| | Reactor | oriented reactor system with gas feed at bottom and with the |
| | | outlet at the top. Vertical cooling tubes are positioned in the |
| | | bed, and internal cyclones (up to 3 in series) are located at the |
| | | top. Typical diameter of the reactor is greater than about 3 |
| | | feet (0.9 m) and less than about 20 feet (6.1 m). Height of |
| | | fluid bed is between about 30 feet (9.2 m) and about 50 feet |
| | | (15.4 m), with a total height of about 80 feet (24.6 m) for the |
| | | reactor. The fixed bed version of the reactor is a vertical |
| | | exchanger type catalytic reactor with tubes from about 1 to 1.5 |
| | | inches (0.4 to 0.6 cm) diameter. The reactor temperature of |
| | | >400° C. requires a construction material that can withstand |
| | | the high temperature, such as a high nickel alloy. |
| 120 | Methyl Conversion | Fixed or fluid bed reactor containing a zeolite or other |
| | Unit | condensation catalyst. Methyl chloride is condensed using |
| | | standard conditions for this reaction known to those of skill in |
| | | the art to condense methyl chloride and form ethylene and |
| | | hydrogen chloride. |
| 130 | Cool & Condenser | Effluent gas from reactor 110 is cooled with a graphite block |
| | | or graphite tube heat exchanger. The condensate has both a |
| | | concentrated HCl aqueous phase and an organic phase. |
| | | Typically, the condenser comprises a series of heat exchangers |
| | | to cool the off gas from the reactor from 400° C. to between |
| | | 2° C. and 10° C. Part of the off gas condenses and goes to the |
| | | Phase Separation block 150. The gas phase goes to the |
| | | Product Split block 140. |
| 140 | Product Split | A separation column, with refrigerated condensers at the top |
| | | to allow separation of the lights for recycle from the |
| | | chlorinated organics, is preferably used for this splitting |
| | | operation. The gaseous compounds may include ethane, |
| | | ethylene, CO, CO₂, nitrogen, and HCl traces. |
| 150 | Phase Separation | Gravity separation of the aqueous and organic phases from |
| | | Cool & Condenser 130 is preferably achieved with a |
| | | horizontal tank provided with internal baffles to allow the |
| | | heavy phase (most likely the aqueous/acid phase, but the |
| | | nature of the phases depends on the exact composition of |
| | | organics in the phases) to be removed from one end of the |
| | | vessel. The lighter phase flows over the baffle into the second |
| | | half of the vessel for removal. The aqueous phase is then, in |
| | | some embodiments, stripped of organics. |
| 160 | HCl Recovery | The aqueous HCl stream from the separator is recovered as |
| | | anhydrous HCl for recycle to the reactor using traditionally |
| | | deployed approaches which are apparent to those of skill. |
| 170 | Drying | Prior to the final separation of the VCM from the other |
| | | products, water is removed in a drying column. The pressure |
| | | and temperature are adjusted such that the water is removed |
| | | from the bottom of the column and the dry product is removed |
| | | from the top. |
| 180 | VCM Purification | Final purification of the VCM product as practiced in industry. |
| | | This is typically a distillation process to separate the |
| | | chlorinated hydrocarbons remaining in the stream.. |
| 190 | EDC Recovery | Standard distillation columns for the purification of EDC. |
| 200 | VCM Polymerization | Standard reactor and equipment employed to polymerize |
| | Reactor | VCM to form polyvinyl chloride (PVC). Standard conditions |
| | | are employed to effect the polymerization. Gaseous, |
| | | unreacted methyl chloride exits the polymerization reactor. |
| 210 | HCl Absorption | The HCl-containing stream from the product split block 140 is |
| | | recovered as aqueous HCl for recycle to the HCl Recovery |
| | | block 160 (or otherwise) using traditionally deployed |
| | | approaches which are apparent to those of skill. |
| 220 | C2 Absorption and | Recovery of ethylene and any ethane in the purge stream is |
| | Stripper | achieved by absorption into a hydrocarbon or other absorbing |
| | | liquid in an absorber, with a stripping operation in a second |
| | | column. The recovered hydrocarbons are then recycled via |
| | | line 221 “back” to the main recycle stream 143 and further to |
| | | the oxidative chlorination reactor 110. |
| 230 | Vent Treatment | Vent treatment is achieved with an incinerator for the |
| | | oxidation of organics (including chlorinated organics) to water |
| | | vapor, carbon dioxide, and hydrogen chloride. The vent gas is |
| | | scrubbed with water to recover HCl as a relatively dilute (10 |
| | | to 20% HCl stream) for other uses. This unit is typical of |
| | | those found throughout the chemical industry and should be |
| | | apparent to those of skill. |
| 240 | Hydrochlorination | A standard hydrochlorination reactor for converting methanol |
| | Unit | to a methyl halide such as methyl chloride. A hydrogen halide |
| | | and methanol are fed and reacted under conventional |
| | | conditions, with or without a catalyst, to form the methyl |
| | | halide. Water, a co-product, is removed. |
| 250 | Hydrogenation Unit | A conventional reactor where dichloroethylene is |
| | | hydrogenated in the presence of hydrogen and a commercially |
| | | available hydrogenation catalyst to produce dichloroethane |
| | | (EDC). Standard process conditions and equipment are |
| | | employed to carry out this process step, all of which is well |
| | | known in the industry. |

The following examples are provided as an illustration of the process of this invention; but the examples should not be construed as limiting the invention in any manner. In light of the disclosure herein, those of skill in the art will recognize alternative embodiments of the invention that fall within the scope of the claims.

### EXAMPLE 1

A catalyst composition comprising a porous lanthanum oxychloride was prepared as follows. Lanthanum chloride (LaCl₃ 7 H₂O, 15 g) was dissolved in deionized water (100 ml) in a round-bottom flask. Ammonium hydroxide (6 M, 20 ml) was added to the lanthanum chloride solution with stirring. The mixture was centrifuged, and the excess liquid was decanted to yield a gel. In a separate container, calcium lactate (0.247 g, 0.0008 moles) was dissolved to form a saturated solution in deionized water. The calcium lactate solution was added with stirring to the lanthanum-containing gel. The gel was dried at 120° C. overnight. A dried solid was recovered, which was calcined under air in an open container at 550° C. for 4 hours to yield a porous lanthanum oxychloride catalyst (6.84 g). X-ray diffraction of the solid indicated the presence of a quasi-crystalline form of lanthanum oxychloride.

The catalyst prepared hereinabove was crushed to 20×40 US mesh (0.85×0.43 mm) and evaluated in the oxidative chlorination of methane as follows. A tubular, nickel alloy reactor, having a ratio of length to diameter of 28.6/1 {6 inches (15.24 cm)×0.210 inches (0.533 cm)} was loaded with catalyst (2.02 g). The reactor was fed a mixture of methane, hydrogen chloride, and oxygen in the ratios shown in Table 1. The operating temperature was 400° C., and the operating pressure was atmospheric. The exit gases were analyzed by gas phase chromatography. Results are set forth in Table 1.

TABLE 1
Conversion of Methane Over Lanthanum
Catalyst to Methyl Chloride

| Mole | | Conv | | | Sel | Sel | | |
|---|---|---|---|---|---|---|---|---|
| Ratio | WHSV | CH₄ | Conv HCl | Conv O₂ | CH₃Cl | CH₂Cl₂ | Sel CO | Sel CO₂ |
| CH₄:HCl:O₂ | h⁻¹ | (mol %) | (mol %) | (mol %) | (mol %) | (mol %) | (mol %) | (mol %) |
| 2:1:0.86 | 8.41 | 5.0 | 12.2 | 14.7 | 72.8 | 12.1 | 13.5 | 1.6 |
| 2:1:0.86 | 4.17 | 13.3 | 29.2 | 30.0 | 62.6 | 18.0 | 16.1 | 2.2 |
| 2:1:0.43 | 4.30 | 12.4 | — | 42.3 | 71.0 | 16.3 | 10.8 | 1.3 |
| 2:1:0.43 | 8.43 | 6.1 | — | 23.3 | 83.5 | 10.2 | 6.4 | 0.0 |

1. Process Conditions: 400° C., atmospheric pressure

### EXAMPLE 2

This example illustrates an oxidative chlorination utilizing both methane and ethylene as hydrocarbon feeds. The catalyst was prepared by the following method. A solution of lanthanum chloride in water was prepared by dissolving one part of commercially available hydrated lanthanum chloride (Alfa Aesar) in 6.6 parts of deionized water. Rapid addition with stirring of 1.34 parts 6 M ammonium hydroxide in water caused the formation of a gel. The mixture was centrifuged, and the solution was decanted away from the gel and discarded. The collected gel was dried at 120° C. overnight and then calcined at 550° C. for 4 hours in air to yield an example of the catalyst. The XRD pattern matched that of LaOCl.

The catalyst was loaded into a nickel reactor with length/diameter ratio of 20/1. The reactor was brought to operating conditions of 452C and near-ambient pressure. A feed containing methane/ethylene/hydrogen chloride/argon/oxygen in a molar ratio of 2.68:0.30:1.99:0.16:1:00 was contacted with the catalyst at a space-time of 7.6 sec. Conversions of the reactants were as follows: ethylene, 46.4 percent; methane, 17.4 percent; hydrogen chloride, 36.4 percent; oxygen, 44.2 percent (calculated as mole percentages). Both methane and ethylene were consumed. Molar carbon selectivities were as follows: vinyl chloride, 24.7 percent; 1,2-dichloroethane, 6.1 percent; dichloroethylenes, 5.8 percent; methyl chloride 38.3 percent; methylene chloride, 12.5 percent; carbon monoxide, 11.3 percent; and carbon dioxide, 1.2 percent. If it is assumed that the chlorinated methanes can be converted quantitatively to ethylene in a condensation reactor, these results allow calculation of an assumed product distribution for an envisioned methane to vinyl chloride process. Such a calculation yields molar selectivities on methane as follows: vinyl chloride monomer, 50.3 percent; 1,2-dichloroethane, 12.5 percent; 1,2-dichloroethylenes, 11.8 percent; carbon monoxide, 22.9 percent; and carbon dioxide, 2.5 percent.

1. A process of preparing a vinyl halide stream comprising vinyl halide monomer or polyvinyl halide, comprising:
(a) contacting methane with a first source of halogen, and optionally, a first source of oxygen in the presence of a first oxidative halogenation catalyst under process conditions sufficient to prepare methyl halide, the catalyst comprising a rare earth halide or rare earth oxyhalide being essentially free of iron and copper, with the proviso that when the catalyst contains cerium, the catalyst also contains at least one other rare earth element;
(b) contacting the methyl halide with a condensation catalyst under condensation conditions sufficient to prepare ethylene and co-product hydrogen halide;
(c) contacting the ethylene from process step (b) with a second source of halogen, and optionally, a second source of oxygen in the presence of a second oxidative halogenation catalyst under oxidative halogenation process conditions, and optional thermal cracking conditions, sufficient to prepare a vinyl halide stream containing vinyl halide monomer, and wherein the resulting vinyl halide stream may contain methyl halide;
(d) separating the vinyl halide monomer from any methyl halide present in the stream;
(e) optionally recycling the methyl halide from process step (d) to process step (b);
(f) recovering the co-product hydrogen halide; and
(g) optionally, recycling the co-product hydrogen halide to process steps (a) and/or (c).

2. The process of claim 1 wherein both sources of halogen are each hydrogen chloride, and oxygen is employed in process steps (a) and (c).

3. The process of claim 1 wherein the sources of oxygen are provided as essentially pure oxygen, or air, or oxygen-enriched air.

4. The process of claim 1 wherein in step (a) the rare earth halide or rare earth oxyhalide is a rare earth chloride or rare earth oxychloride.

5. The process of claim 1 wherein the rare earth is lanthanum or lanthanum in a mixture with other rare earth elements.

6. The process of claim 1 wherein in step (a) the temperature is greater than about 200° C. and less than about 600° C., and wherein the pressure is equal to or greater than about 14 psia (97 kPa) and less than about 150 psia (1,034 kPa).

7. The process of claim 1 wherein the condensation catalyst is selected from the group consisting of aluminosilicates of the DCM-2 and ZSM structure codes, aluminophosphates, borosilicates, silicates, and silicoaluminophosphates.

8. The process of claim 1 wherein the condensation process temperature is greater than about 250° C. and less than about 600° C., and wherein the condensation process pressure is greater than about 0.1 psi absolute (689 Pa) and less than about 300 psi absolute (2,068 kPa).

9. The process of claim 1 wherein in step (c) the second oxidative halogenation catalyst comprises a rare earth halide or rare earth oxyhalide being essentially free of iron and copper, with the proviso that when the catalyst contains cerium, the catalyst also contains at least one other rare earth element.

10. The process of claim 1 wherein process steps (a) and (c) occur simultaneously in a single reactor.

11. The process of claim 1 wherein separation step (d) is effected by polymerizing the vinyl halide monomer to polyvinyl halide.

12. The method of manufacturing a vinyl chloride stream containing either vinyl chloride monomer or polyvinyl chloride, comprising the steps of
(a) generating a first reactor effluent stream by catalytically reacting together methane, oxygen, and at least one chlorine source in an oxidative chlorination reactor to form methyl chloride;
(b) condensing the methyl chloride to form ethylene;
(c) generating a second reactor effluent stream by catalytically reacting together the ethylene, oxygen, and at least one chlorine source to form vinyl chloride;
(d) cooling and condensing said first reactor effluent stream to provide a raw product stream having a first portion of hydrogen chloride and a raw cooled hydrogen chloride stream having a second portion of hydrogen chloride;
(e) separating said raw product stream into a vinyl chloride monomer product stream that optionally may contain methyl chloride and into a lights stream having said first portion of the hydrogen chloride;
(f) optionally, separating the first portion of hydrogen chloride from the lights stream to form a second lights stream that may be recycled to the oxidative chlorination reactor of step (a) and recovering a first hydrogen chloride stream from the first portion of hydrogen chloride and conveying the first hydrogen chloride stream to a hydrogen chloride recovery subsystem;
(g) conveying the raw cooled hydrogen chloride stream having the second portion of hydrogen chloride from step (d) to a hydrogen chloride recovery subsystem;
(h) in the hydrogen chloride recovery subsystem, recovering hydrogen chloride from the first hydrogen chloride stream and from the raw cooled hydrogen chloride stream having a second portion of hydrogen chloride;
(i) sending the recovered hydrogen chloride to the oxidative chlorination reactor of step (a);
j) separating the vinyl chloride and any methyl chloride in the vinyl chloride stream to form a purified vinyl chloride stream, and optionally,
(k) recycling any methyl chloride recovered to condensation step (b).

13. The method of claim 12 wherein the catalytically reacting steps (a) and (c) use a catalyst comprising a rare earth material component, with the proviso that the catalyst is substantially free of iron and copper and with the further proviso that when the rare earth material component is cerium the catalyst further comprises at least one more rare earth material component other than cerium.

14. The method of claim 13 wherein the rare earth material component is selected from lanthanum, neodymium, praseodymium, and mixtures thereof.

15. The method of claim 14 wherein the rare earth material component is lanthanum.

16. The method of claim 12 wherein one said chlorine source is selected from at least one of a chlorinated methane and a chlorinated ethane.

17. The method of claim 12 wherein said chlorine source in step (a) or step (c), or both steps (a) and (c), is selected from at least one of the chlorinated organic compounds consisting of carbon tetrachloride, 1,2-dichloroethane, ethyl chloride, 1,1-dichloroethane, and 1,1,2-trichloroethane.

18. The method of claim 12 wherein the separation step (j) is effected by polymerizing the vinyl halide monomer to polyvinyl halide.

19. An apparatus for making vinyl halide, comprising:
(a) a first reactor that catalytically reacts together methane, oxygen, and at least one halogen source to form methyl halide;
(b) a second reactor that condenses the methyl halide to form ethylene;
(c) a third reactor that catalytically reacts together the ethylene, oxygen, and at least one halogen source to form vinyl halide monomer;
(d) a separation subsystem that separates a stream containing the vinyl halide from any methyl halide present in the stream;
(e) a recovery subsystem for recovering and optionally recycling hydrogen halide;
(f) optionally, a line for recycling the recovered methyl halide to the second reactor in (b);
(g) optionally, a line for recycling the recovered hydrogen halide to the first and/or third reactors in (a) and (c).

20. The apparatus of claim 19 wherein the first and third reactors are combined in a single reactor.

21. The apparatus of claim 19 wherein the separation subsystem (d) comprises a polymerization reactor for polymerizing vinyl halide monomer to polyvinyl halide.

22. A process of preparing a vinyl halide stream comprising vinyl halide monomer or polyvinyl halide, comprising:
(a) converting methanol to methyl halide by contacting methanol with hydrogen halide;
(b) contacting the methyl halide with a condensation catalyst under condensation conditions sufficient to prepare ethylene and co-product hydrogen halide;
(c) contacting the ethylene from process step (b) with a second source of halogen, and optionally, a second source of oxygen in the presence of an oxidative halogenation catalyst under oxidative halogenation process conditions, and optional thermal cracking conditions, sufficient to prepare a vinyl halide stream containing vinyl halide monomer, and wherein the resulting vinyl halide stream may contain methyl halide;
(d) separating the vinyl halide monomer from any methyl halide present in the stream;
(e) optionally recycling the methyl halide from process step (d) to process step (b);
(f) recovering the co-product hydrogen halide; and
(g) optionally, recycling the co-product hydrogen halide to process steps (a) and/or (c).

23. The process of claim 22 wherein both sources of halogen are each hydrogen chloride, and oxygen is employed in process step (c).

24. The process of claim 22 wherein the source of oxygen is provided as essentially pure oxygen, or air, or oxygen-enriched air.

25. The process of claim 22 wherein in step (c) the rare earth halide or rare earth oxyhalide is a rare earth chloride or rare earth oxychloride being essentially free of iron and copper, with the proviso that when the catalyst contains cerium, the catalyst also contains at least one other rare earth element.

26. The process of claim 25 wherein the rare earth is lanthanum or lanthanum in a mixture with other rare earth elements.

27. The process of claim 22 wherein in step (c) the temperature is greater than about 200° C. and less than about 600° C., and wherein the pressure is equal to or greater than about 14 psia (97 kPa) and less than about 150 psia (1,034 kPa).

28. The process of claim 22 wherein the condensation catalyst is selected from the group consisting of aluminosilicates of the DCM-2 and ZSM structure codes, aluminophosphates, borosilicates, silicates, and silicoaluminophosphates.

29. The process of claim 22 wherein the condensation process temperature is greater than about 250° C. and less than about 600° C., and wherein the condensation process pressure is greater than about 0.1 psi absolute (689 Pa) and less than about 300 psi absolute (2,068 kPa).

30. The process of claim 22 wherein separation step (d) is effected by polymerizing the vinyl halide monomer to polyvinyl halide.

31. A process of preparing a vinyl chloride stream comprising vinyl chloride monomer or polyvinyl chloride, the process comprising:
(a) converting methanol to methyl chloride;
(b) contacting the methyl chloride with a condensation catalyst under condensation conditions sufficient to prepare ethylene and co-product hydrogen chloride;
(c) contacting the ethylene from process step (b) with a source of halogen, and optionally, a source of oxygen in the presence of an oxidative halogenation catalyst under oxidative halogenation process conditions, and optional thermal cracking conditions, sufficient to prepare a vinyl chloride monomer stream wherein the resulting vinyl chloride monomer stream may contain methyl chloride;
(d) cooling and condensing said chlorination reactor effluent stream to provide a raw product stream having a first portion of hydrogen chloride and a raw cooled hydrogen chloride stream having a second portion of hydrogen chloride;
(e) separating said raw product stream into a vinyl chloride monomer product stream that optionally contains methyl chloride and into a lights stream having said first portion of the hydrogen chloride;
(f) optionally, separating the first portion of hydrogen chloride from the lights stream to form a second lights stream that may be recycled to the oxidative chlorination reactor of step (c) and recovering a first hydrogen chloride stream from the first portion of hydrogen chloride and conveying the first hydrogen chloride stream to a hydrogen chloride recovery subsystem;
(g) conveying the raw cooled hydrogen chloride stream having the second portion of hydrogen chloride from step (d) to a hydrogen chloride recovery subsystem;
(h) in the hydrogen chloride recovery subsystem, recovering hydrogen chloride from the first hydrogen chloride stream and from the raw cooled hydrogen chloride stream having a second portion of hydrogen chloride;
(i) sending the recovered hydrogen chloride to the oxidative chlorination reactor of step (c);
(j) separating the vinyl chloride and any methyl chloride from the vinyl chloride product stream to form a purified vinyl chloride stream, and optionally,
(k) recycling any methyl chloride recovered to step (b) for condensation to ethylene.

32. The process of claim 31 wherein the methanol is formed by hydrolyzing methyl chloride, the methyl chloride being prepared by contacting methane, a chlorine source, and optionally oxygen, in the presence of an oxidative halogenation catalyst under process conditions sufficient to prepare methyl chloride, the catalyst comprising a rare earth halide or rare earth oxyhalide being essentially free of iron and copper, with the proviso that when the catalyst contains cerium, the catalyst also contains at least one other rare earth element.

33. The process of claim 32 wherein the source of halogen in preparing methyl chloride is hydrogen chloride, and oxygen is employed.

34. The process of claim 32 wherein the rare earth halide or rare earth oxyhalide is a rare earth chloride or rare earth oxychloride.

35. The process of claim 34 wherein the rare earth is lanthanum or lanthanum in a mixture with other rare earth elements.

36. The process of claim 31 wherein the condensation catalyst is selected from the group consisting of aluminosilicates of the DCM-2 and ZSM structure codes, aluminophosphates, borosilicates, silicates, and silicoaluminophosphates.

37. The process of claim 31 wherein the condensation process temperature is greater than about 250° C. and less than about 600° C., and wherein the condensation process pressure is greater than about 0.1 psi absolute (689 Pa) and less than about 300 psi absolute (2,068 kPa).

38. The process of claim 31 wherein in step (c) the oxidative halogenation catalyst comprises a rare earth halide or rare earth oxyhalide being essentially free of iron and copper, with the proviso that when the catalyst contains cerium, the catalyst also contains at least one other rare earth element.

39. The process of claim 31 wherein in step (c) the temperature is greater than about 200° C. and less than about 600° C., and wherein the pressure is equal to or greater than about 14 psia (97 kPa) and less than about 150 psia (1,034 kPa).

40. The process of claim 31 wherein the separation step (j) is effect by polymerizing vinyl chloride monomer to polyvinyl chloride.

41. The process of claim 31 further comprising recovering cis/trans-1,2-dihaloethylene from the vinyl halide monomer stream and hydrogenating the recovered cis/trans-1,2-dihaloethylene to form ethylene dihalide.

42. An apparatus for making a vinyl halide stream comprising vinyl halide monomer or polyvinyl halide, the apparatus comprising: (a) a first reactor that converts methanol to methyl halide; (b) a second reactor that condenses the methyl halide to form ethylene and hydrogen halide; (c) a third reactor that catalytically reacts together the ethylene, oxygen, and at least one halogen source to form a stream comprising vinyl halide monomer and optionally methyl halide; (d) a recovery subsystem for the recovery of hydrogen halide; (e) a separation subsystem that separates the stream containing vinyl halide monomer and any methyl halide present to provide a vinyl halide stream comprising vinyl halide monomer or polyvinyl halide and a methyl halide stream; (f) optionally, a line that recycles the methyl halide to the second reactor (b); and (g) optionally, a line that recycles the recovered hydrogen halide to the first and/or third reactors (a) and (c).

43. The apparatus of claim 42 wherein the separation subsystem comprises a polymerization reactor for polymerizing vinyl halide monomer to polyvinyl halide.

44. The process of claim 1 wherein the hydrogen halide is hydrogen chloride; the methyl halide is methyl chloride; the vinyl halide monomer is vinyl chloride monomer; and the polyvinyl halide is polyvinyl chloride.

45. The process of claim 22 wherein the hydrogen halide is hydrogen chloride; the methyl halide is methyl chloride; the vinyl halide monomer is vinyl chloride monomer; and the polyvinyl halide is polyvinyl chloride.
